(19) United States
(12) Patent Application Publication
(10) Pub. No.: US 2009/0164920 A1
(43) Pub. Date: Jun. 25, 2009

(54) System, method and apparatus for inserting a virtual tool bar into a markup language document

(75) Inventor: William T. Stelle, Lenexa, KS (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: Embarq Holdings Company LLC, Overland Park, KS (US)

(21) Appl. No.: 12/004,803

(22) Filed: Dec. 20, 2007

(51) Int. Cl. G06F 3/048

(52) U.S. Cl. 715/760

(57) ABSTRACT

A method, system and apparatus for inserting a virtual toolbar into a markup language document includes receiving a request for the markup language document from a user device, forwarding the request to a server, receiving the markup language document from the server, and inserting a virtual toolbar into the markup language document to produce a virtual toolbar embedded markup language document.

### BACKGROUND

A toolbar is typically a row, column, or block of onscreen buttons or icons in a graphical user interface on a computer display that, when clicked, activate certain functions of the program. Earlier forms of toolbars were defined by programmers as having set functions. Most modern programs and operating systems however, allow end users to modify and customize toolbars to fit their personal needs. Toolbars for browsers are best known for adding functionality and ease-of-use options to an end user. While the browser itself handles basic browsing navigation such as forward, back stop, and reload, toolbars often add additional functionality to browsers such as additional search fields, form-fill capability, and links back to popular websites.

Various companies offer downloadable toolbars that must be installed on an end user's computer so the end user may use the toolbar in conjunction with a browser to provide quick access to search and other functions from any browser screen. However, these toolbars require the user to download and install the toolbar prior to use. In addition, a different version of the toolbar must be downloaded and installed in order to use the toolbar with a specific browser and/or with a specific operating system. Many users do not wish to install third-party toolbars, and third-party toolbars may present security flaws.

### SUMMARY

Embodiments of the present invention provide for a method, system, and apparatus for inserting a virtual toolbar into a markup language document.

According to one embodiment, a method for inserting a virtual toolbar into a markup language document includes receiving a request for the markup language document from a user device, forwarding the request to a server, receiving the markup language document from the server, and inserting a virtual toolbar into the markup language document to produce a virtual toolbar embedded markup language document.

According to another embodiment, a computer usable program product in a computer readable medium storing computer executable instructions for inserting a virtual toolbar into a markup language document is provided. The computer executable instructions, when executed, cause at least one processor to receive a request for the markup language document from a user device, forward the request to a server, receive the markup language document from the server, and insert a virtual toolbar into the markup language document to produce a virtual toolbar embedded markup language document.

According to still another embodiment, a system for inserting a virtual toolbar into a markup language document includes a server and a toolbar server. The server includes at least one storage device for storing the markup language document. The toolbar server is coupled to the server and is operable to receive a request for the markup language document from a user device, forward the request to a server, receive the markup language document from the server, insert a virtual toolbar into the markup language document to produce a virtual toolbar embedded markup language document, and send the virtual toolbar embedded markup language document to the user device.

### BRIEF DESCRIPTION OF THE DRAWINGS

A more complete understanding of the method and apparatus of the principles of the present invention may be obtained by reference to the following Detailed Description when taken in conjunction with the accompanying Drawings wherein:

FIG. 1 is an illustration of an embodiment of a system for inserting a virtual toolbar into a markup language document;

FIG. 2 is an illustration of an embodiment of a signal flow diagram of a process for inserting a virtual toolbar into a markup language document; and

FIG. 3 is an illustration of an electronic document browser for displaying an embodiment of a virtual toolbar inserted into a markup language document.

### DETAILED DESCRIPTION OF THE DRAWINGS

Various embodiments of the present invention provide for a system and method for inserting a virtual toolbar into a markup language document. A markup language document is an electronic document that has been formatted or encoded in accordance with a markup language. Examples of markup languages include Hypertext Markup Language (HTML), Extensible Markup Language (XML), Standard Generalized Markup Language (SGML), and Extensible HyperText Markup Language (XML). In at least one embodiment, the markup language document is a web page retrieved from a server. A web page may include an electronic document having text and/or graphics that is retrievable by and displayable by an electronic document browser. In a particular embodiment, an electronic document browser is a software application that enables a user to display and interact with text, images, videos, music and other information located in an electronic document, such as a web page, retrieved from a server coupled to an external network or a local area network Examples of electronic document browsers include Microsoft Corporation's Internet Explorer and Mozilla Corporation's Firefox.

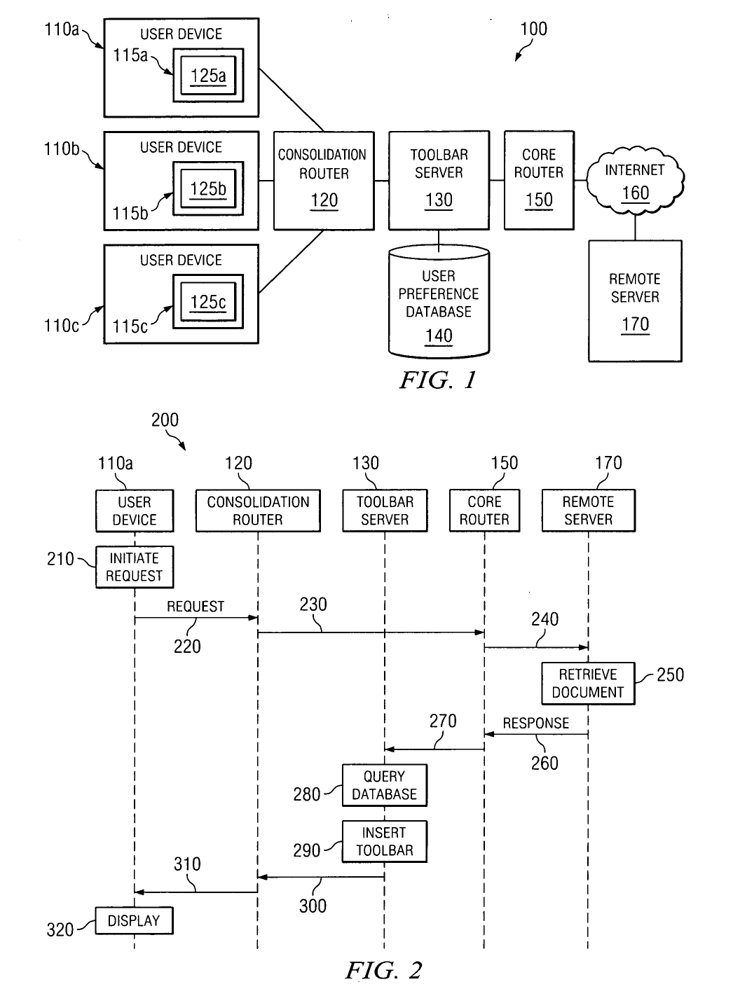

FIG. 1 is an illustration of an embodiment of a system 100 for inserting a virtual toolbar into a markup language document. The system 100 includes a plurality of user devices 110a-110c, a consolidation router 120, a toolbar server 130, a user preference database 140, and a core router 150. Each of the plurality of user devices 110a-110c is coupled to the consolidation router 120. Each of the user devices includes a display 115a-115c. In some embodiments, at least one of the user devices 110a-110c is a computer. In still other embodiments, at least one of the user devices 110a-110c is a handheld device. In various embodiments, each of the user devices 110a-110c may be wired or wirelessly coupled to the consolidation router 120. The consolidation router 120 is further coupled to the toolbar server 130. The consolidation router 120 receives data packets from one or more of the user devices 110a-110c and routes the packets to the toolbar server 130. In addition, the consolidation router 120 receives data packets from the toolbar server 130 and routes the packets to one or more of the user devices 110a-110c.

The toolbar server 130 is further coupled to the core router 150 and the user preference database 140. The user preference database 140 stores toolbar preference information associated with one or more of user device 110a-110c and/or one or more users of the user devices 110a-110c. The core router 150 functions to couple the toolbar server 130 to one or more networks, such as the internet 160. In a particular embodiment, a remote server 170 is coupled to the internet 160. In accordance with various embodiments, each of the user devices 110a-110c includes an electronic document browser 125a-125c having a graphical user interface for retrieving electronic documents from the remote server 170 and displaying the electronic documents. In a particular embodiment, the electronic document browser 125a-125c is a web browser. In at least one embodiment, the toolbar server 130 comprises at least one computer having at least one processor for executing computer instructions operable to cause the toolbar server 130 to receive a request for a markup language document from user device 110a, forward the request to the remote server 170, receive the markup language document from the remote server 170, insert a virtual toolbar into the markup language document to produce a virtual toolbar embedded markup language document, and send the virtual toolbar embedded markup language document to user device 125a. In various embodiments, a virtual toolbar is a user interface in the form of a toolbar that is not built into the functionality of the electronic document browser 125a-125c, but is instead a user interface in the form of a toolbar that is inserted or embedded into a markup language document. In various embodiments, the virtual toolbar is inserted or embedded by a service provider. The virtual toolbar may offer various functions and capabilities provided from the service provider to the user such as searching the web, viewing maps, retrieving news, and/or shopping.

In an example operation of the embodiment of FIG. 1, a user of user device 110a initiates a request for a web page using the electronic document browser 125a. The request flows through the consolidation router 120, the toolbar server 130, and the core router 150 to the internet 160. The request is received by the remote server 170, and the remote server 170 sends the requested web page via the internet 160 to the core router 150. The core router 150 routes the request to the toolbar server 130. The toolbar server 130 queries the user preference database 140 for toolbar preferences information associated with the user and/or the user device 110a, inserts a virtual toolbar configured in accordance with the toolbar preference information into the web page to produce a virtual toolbar embedded web page, and sends the virtual toolbar embedded web page to the user device 110a via the consolidation router 120. The virtual toolbar embedded web page is then displayed to the user of the user device 110a via the display 115a. The user of the device 110a may then use functions and capabilities provided by the virtual toolbar via the graphical user interface. For example, the user may search the web, view maps, retrieve news, and/or shop using the virtual toolbar.

FIG. 2 is an illustration of an embodiment of a signal flow diagram of a procedure 200 for inserting a virtual toolbar into a markup language document. In step 210, the user device 110a initiates a request to retrieve a markup language document from a remote server 170. In at least one embodiment, the remote server 170 includes at least one storage device for storing the markup language document. In still other embodiments, the remote server 170 is coupled to at least one storage device for storing the markup language document. In at least one embodiment, the markup language document is a web page. In a particular embodiment, the request is a Hypertext Transfer Protocol (HTTP) request initiated by a user of the user device 110a via a web browser. In step 220, the user device 110a sends the request to the consolidation router 120. In step 230, the request is forwarded from the consolidation router 120 to the core router 130. In an alternative embodiment, the request may pass through the toolbar server 130 before being sent to the core router 120. In step 240, the core router 150 forwards the request to the remote server 170. In at least one embodiment, the core router 150 forwards the request to the remote server 170 via the internet 160. In at least one embodiment, the remote server 170 is a web server. Although the embodiment of FIG. 1 is illustrated as including a remote server 170, it should be understood that in other embodiments the remote server 170 can be replaced by a server that is local to the toolbar server 130.

In response to receiving the request, the remote server 170 retrieves the markup language document in step 250. In step 260, the remote server 170 sends a response including the requested markup language document to the core router 150. The core router 150 forwards the response to the toolbar server 130 in step 270. In step 280, the toolbar server 130 queries the user preference database 140 and retrieves toolbar preference information associated with the user device 110a and/or the user. The toolbar preference information includes information such as a desired location of the virtual toolbar within the markup language document, and desired functions and capabilities to be provided by the virtual toolbar. In step 290, the toolbar server 130 inserts a virtual toolbar configured in accordance with the toolbar preference information into the markup language document to produce a virtual toolbar embedded markup language document. In a particular embodiment, the inserting of the virtual toolbar into the markup language document includes inserting markup language document code representing the virtual toolbar into markup language code representing the original markup language document. In step 300, the toolbar server 130 sends the virtual toolbar embedded markup language document to the consolidation router 120. In step 310, the consolidation router 120 sends the virtual toolbar embedded markup language document to the user device 110a. In step 320, the virtual toolbar embedded web page is displayed to the user of the user device 110a via the display 115a. In accordance with various embodiments, the user of the user device 110a can interact with the virtual toolbar to perform various functions and capabilities provided by the virtual toolbar, such as searching the web, viewing maps, retrieving news, and/or shopping.

The various steps of procedure 200 have been chosen and described only as exemplary and are not limiting on the illustrative embodiments. An implementation of the illustrative embodiments may alter, combine, delete or augment these steps without departing from the scope of the illustrative embodiments.

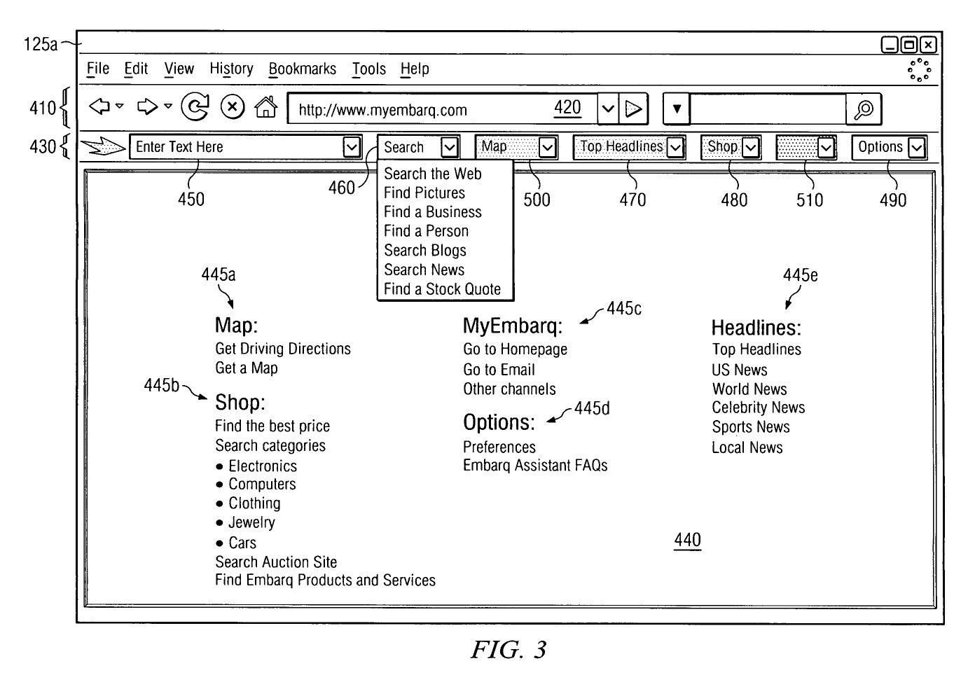

FIG. 3 is an illustration of an electronic document browser 125a for displaying an embodiment of a virtual toolbar 430 inserted into a markup language document 440. In accordance with at least one embodiment, the electronic document browser 125a is displayed on display 115a of user device 110a. The electronic document browser 125a includes a built-in toolbar 410 providing functions such as forward, back reload, and stop. The built-in toolbar 410 includes a universal resource locator (URL) text entry field 420 through which a user may enter a URL address of a particular markup language document that the user wishes to retrieve. In the embodiment illustrated, virtual toolbar 430 is inserted at the top of the markup language document 440 by toolbar server 130. In still other embodiments, the virtual toolbar 430 can be inserted at any location within the markup language document 440 by toolbar server 130. In at least one embodiment, the location of virtual toolbar 430 within the markup language document 440 is determined in accordance with toolbar preference information retrieved from user preference database 140 by toolbar server 130.

In an example operation of the embodiment illustrated in FIG. 3, a user enters an address of “http://www.myembarq.com” into the URL text entry field 420. In a particular embodiment, a request 220 for the markup language document is sent to remote server 170, and remote server 170 sends the markup language document to toolbar server 130. Toolbar server 130 inserts the virtual toolbar 430 into the markup language document to produce a virtual toolbar embedded markup language document 440 configured in accordance with toolbar preference information queried and received from user preference database 140, and sends the virtual toolbar embedded markup language document 440 to the user device 110a for display by the electronic document browser 125a in the display 115a. In the illustrated embodiment, the virtual toolbar 430 is inserted by the toolbar server 130 into the markup language document so that it is displayed at the top of the virtual toolbar embedded markup language document 440. In other embodiments, the virtual toolbar 430 can be displayed in any portion of the virtual toolbar embedded markup language document 440. In various embodiments, the location of the virtual toolbar 430 in the virtual toolbar embedded markup language document 440 is determined in accordance with user preferences associated with the user device 110a stored in the user preference database 140. In accordance with various embodiments, the virtual toolbar 430 is inserted into the markup language document retrieved from the remote server 170 such that no other content changes are made to the markup language document when producing the virtual toolbar embedded markup language document 440. In accordance with some embodiments, the toolbar server 130 inserts the virtual toolbar 430 at the top of the markup language document and resizes fonts and/or graphics in the markup language document so that the original size of the markup language is unchanged to produce the virtual toolbar embedded markup language document 440. In still other embodiments, the toolbar server 130 inserts the virtual toolbar 430 into the markup language document without making any other changes to the markup language document to produce the virtual toolbar embedded markup language document 440. In still other embodiments, the virtual toolbar server 130 inserts the virtual toolbar 430 into a location other than the top of the markup language document to produce the virtual toolbar embedded markup language document 440.

In the embodiment illustrated in FIG. 3, portions 445a-e of the virtual toolbar embedded markup language document 440 that are contained in the original markup language document sent from the remote server 170 include a “Map” portion 445a, a “Shop” portion 445b, a “MyEmbarq” portion 445c, an “Options” portion 445d, and a “Headlines” portion 445e. The “Map” portion 445a allows a user to get driving directions or a map of a location. The “Shopping” portion 445b allows a user to find the best price for a product, or search for products in a variety of categories including electronics, computers, clothing, jewelry, and cars. The “Shopping” portion 445b further allows a user to search an auction site or find Embarq products and services. The “MyEmbarq” portion 445c allows a user to go to a personal webpage, check email, or view other information channels. The “Headlines” portion 445e allows a user to view news such as top headlines, U.S. news, world news, celebrity news, sports news, or local news. The “Options” portion 445d allows a user to change toolbar preference information stored in the user preference database 140 or view Frequently Asked Questions (FAQs).

The virtual toolbar 430 includes a search text entry field 450 and a drop-down search selection menu 460. The search text entry field 450 allows a user to enter a text query for which the user wishes to search. The drop-down search selection menu 460 allows a user to select a search category for which the user wishes to search using the text query entered into the search text entry field 450. In the embodiment illustrated in FIG. 3 the drop-down search selection menu 460 includes search categories of searching the web, finding pictures, finding a business, finding a person, searching web logs (blogs), searching news, and finding a stock quote. In an example operation of the virtual toolbar 430, a user enters a text query into the search text entry field 450 and selects “Search the web” from the drop-down search selection menu 460. In response to the selection, the user device 110a sends a search query including the entered text to a search engine connected to the internet 160. The search engine sends search results to the user device 110a, and the electronic document browser 125a displays the search results to the user. In a particular embodiment of the invention, the search engine is provided by a vendor via an agreement with a provider of the toolbar server 130.

The virtual toolbar 430 further includes a drop-down map search selection menu 500 that allows a user to search for maps or driving directions related to text entered into the search text entry field 450. A drop-down headlines selection menu 470 allows the user to search for news items, and a drop-down shopping selection menu 480 allows the user to select categories for shopping for items. The virtual toolbar 430 further includes a drop-down options selection menu 490 that allows a user to change user preference information stored in the user preference database 140 or view Frequently Asked Questions (FAQs). A drop-down map menu 500 of the virtual toolbar 430 allows a user to get driving directions or a map of a location, and a MyEmbarq drop-down menu 510 allows a user to go to a personal webpage, check email, or view other information channels. It should be understood that the virtual toolbar 430 illustrated in FIG. 3 is representative of at least one embodiment. Other configurations of the virtual toolbar 430 providing other functions may be provided in accordance with other embodiments.

One advantage provided by the virtual toolbar 430 of various embodiments is that a user is not required to download and install an executable program in order to use the virtual toolbar 430. Another advantage provided by various embodiments of the virtual toolbar 430 is that the virtual toolbar 430 is inserted into the top of every webpage visited by a user, regardless of the browser being used. Another advantage of certain embodiments of the virtual toolbar 430 is that the supplier of the virtual toolbar 430 may capture a portion of online search revenue by providing access to search engines to a user via the virtual toolbar 430.

Although the embodiment illustrated in FIG. 1 includes consolidation router 120 and core router 150, it should be understood that in other embodiments these components may be omitted such that user devices 110a-110c are coupled to the toolbar server 130, and the toolbar server 130 is coupled to the remote server 170. In still other embodiments, the functions of the toolbar server 130 can instead be performed by the user device 110a-110c such that the user device 110a-110c retrieves a markup language document and inserts the virtual toolbar 430 into the markup language document.

The illustrative embodiments can take the form of an entirely hardware embodiment, an entirely software embodiment or an embodiment containing both hardware and software elements. Furthermore, the illustrative embodiments can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory, a read-only memory (ROM), a rigid magnetic disk and an optical disk. Current examples of optical disks include compact disk-read only memory (CD-ROM), compact disk-read/write (CD-R/W) and DVD.

Further, a computer storage medium may contain or store a computer-readable program code such that when the computer-readable program code is executed on a computer, the execution of this computer-readable program code causes the computer to transmit another computer-readable program code over a communication link. This communication link may use a medium that is, for example without limitation, physical or wireless.

The above description has been presented for purposes of illustration and description, and is not intended to be exhaustive or limited to the illustrative embodiments in the form disclosed. Many modifications and variations will be apparent to those of ordinary skill in the art.

What is claimed:

1. A method for inserting a virtual toolbar into a markup language document comprising:
receiving a request for the markup language document;
forwarding the request to a server,
receiving the markup language document from the server, and
inserting a virtual toolbar into the markup language document to produce a virtual toolbar embedded markup language document.

2. The method of claim 1, wherein the request is received from a user device and the method further comprises:
querying a user preference database for toolbar preference information associated with the user device; and
receiving the toolbar preference information from the user preference database.

3. The method of claim 2, further comprising configuring the virtual toolbar in accordance with the toolbar preference information.

4. The method of claim 1, wherein the inserting of the virtual toolbar into the markup language document comprises inserting markup language document code representing the virtual toolbar into markup language code of the markup language document.

5. The method of claim 1, further comprising configuring the virtual toolbar to provide at least one function.

6. The method of claim 1, wherein the virtual toolbar includes a text entry field operable to allow a user to enter a text query for sending to a search engine.

7. The method of claim 1, further comprising:
Sending the virtual toolbar embedded markup language document to a user device; and
displaying the virtual toolbar embedded markup language document using the user device.

8. A computer usable program product in a computer readable medium storing computer executable instructions for inserting a virtual toolbar into a markup language document that, when executed, cause at least one processor to:
receive a request for the markup language document from a user device;
forward the request to a server,
receive the markup language document from the server; and
insert a virtual toolbar into the markup language document to produce a virtual toolbar embedded markup language document.

9. The computer usable program product of claim 8, wherein the executable instructions further cause the at least one processor to:
query a user preference database for toolbar preference information associated with a user device; and
receive the toolbar preference information from the user preference database.

10. The computer usable program product of claim 9, wherein the executable instructions further cause the at least one processor to configure the virtual toolbar in accordance with the toolbar preference information.

11. The computer usable program product of claim 8, wherein the inserting of the virtual toolbar into the markup language document comprises inserting markup language document code representing the virtual toolbar into markup language code of the markup language document.

12. The computer usable program product of claim 8, wherein the executable instructions further cause the at least one processor to configure the virtual toolbar to provide at least one function to a user.

13. The computer usable program product of claim 8, wherein the virtual toolbar includes a text entry field operable to allow a user to enter a text query for sending to a search engine.

14. A system for inserting a virtual toolbar into a markup language document comprising:
a server including at least one storage device for storing the markup language document; and
a toolbar server coupled to the server, the toolbar server operable to:
receive a request for the markup language document from a user device;
forward the request to a server;
receive the markup language document from the server;
insert a virtual toolbar into the markup language document to produce a virtual toolbar embedded markup language document; and
send the virtual toolbar embedded markup language document to the user device.

15. The system of claim 14, further comprising:
a user preference database for storing toolbar preference information associated with the user device.

16. The system of claim 15, wherein the toolbar server is further operable to:
query the user preference database for the toolbar preference information; and
receive the toolbar preference information from the user preference database.

17. The system of claim 16, wherein the toolbar server is further operable to configure the virtual toolbar in accordance with the toolbar preference information.

18. The system of claim 14, wherein the inserting of the virtual toolbar into the markup language document comprises inserting markup language document code representing the virtual toolbar into markup language code of the markup language document.

19. The system of claim 14, wherein the toolbar server is further operable to configure the virtual toolbar to provide at least one function to a user of the user device.

20. The system of claim 14, wherein the user device operable to display the virtual toolbar embedded markup language document.
